(19) United States
(12) Patent Application Publication
(10) Pub. No.: US 2021/0319763 A1
(43) Pub. Date: Oct. 14, 2021

(54) GOA CIRCUIT AND DISPLAY DEVICE

(71) Applicant: SHENZHEN CHINA STAR OPTOELECTRONICS SEMICONDUCTOR DISPLAY TECHNOLOGY CO., LTD., Shenzhen, Guangdong (CN)

(72) Inventors: Zhida XU, Shenzhen, Guangdong (CN); Xiaohui YAO, Shenzhen, Guangdong (CN); Ilgon KIM, Shenzhen, Guangdong (CN)

(73) Assignee: SHENZHEN CHINA STAR OPTOELECTRONICS SEMICONDUCTOR DISPLAY TECHNOLOGY CO., LTD., Shenzhen, Guangdong (CN)

(21) Appl. No.: 16/960,601

(22) PCT Filed: Apr. 21, 2020
(86) PCT No.: PCT/CN2020/085804

§ 371 Date: Jul. 8, 2020

(30) Foreign Application Priority Data
Apr. 9, 2020 (CN) 202010275735.0

(51) Int. Cl. G09G 3/36

(52) U.S. Cl. CPC G09G 3/3677

(57) ABSTRACT

A gate driver on array (GOA) circuit and a display panel are provided. At least one reverse unit of a nth-stage GOA unit of the GOA circuit is a first reverse unit, which includes three reverse transistors. During an operation stage, when a potential of a first node is low, an input terminal of a maintenance unit is at a high potential, and when the first node is at a high potential, the input terminal of the maintenance unit is at a low potential. Only three transistors are used to achieve that a potential of the first node is opposite to a potential of a signal at the input terminal of the maintenance unit, which saves space.

### FIELD OF INVENTION

The present invention relates to the field of display technologies, and more particularly to a gate driver on array (GOA) circuit and a display device.

### BACKGROUND OF INVENTION

A structure of a current 8K product is illustrated in FIG. 1, including m cascaded GOA modules. A nth-stage GOA module includes a pull-up control module 101, a pull-up module 102, a signal downloading module 103, a first pull-down module 104, a second pull-down module 105, a first pull-down maintenance module 106, and a second pull-down maintenance module 107. The pull-up control module 101 includes a transistor T11, and the pull-up module 102 includes a transistor T21. The signal downloading module 103 includes a transistor T22, and the first pull-down module 104 includes a transistor T31. The second pull-down module 105 includes a transistor T41, and the first pull-down maintenance module 106 includes transistors T51, T52, T53, T54, T32, T42. The second pull-down maintenance module 107 includes transistors T61, T62, T63, T64, T33, and T43. The connection of each transistor is illustrated in the figure. Among each signal, CK is a clock signal, ST(n−6), G(n+6), G(n+8) are all input signals, G(n) and ST(n) are both output signals, and both VSSQ and VSSG are low power supply potential signals. The first pull-down maintenance module 106 and the second pull-down maintenance module 107 have the same structure and are composed of an inverter and two transistors. During driving, an input signal of an input terminal of a low-frequency clock signal of the first pull-down maintenance module 106 is LC1, and an input signal of an input terminal of a low-frequency clock signal of the second pull-down maintenance module 107 is LC2. LC1 and LC2 are a set of low-frequency clock signals with a phase difference of ½ cycle to drive the first pull-down maintenance module 106 and the second pull-down maintenance module 107 to operate alternately. Therefore, when the first pull-down maintenance module 106 or the second pull-down maintenance module 107 operates, the input signal at the input terminal of the corresponding low-frequency clock signal is at a high potential.

FIG. 2 is a schematic structural diagram of the first pull-down maintenance module 106, including an inverter 10 and the transistors T32 and T42. The inverter 10 is composed of 4 transistors, and its operation principle is that: when a potential at a point Q(n) is low, T52 and T54 are turned off, T51 is turned on, so that a potential at a point A is high, and then T53 is turned on, a point P(n) is at a high potential. When a potential at the point Q(n) is high, T52 and T54 are turned on, VSSQ inputs a low potential to the point A, T51 is turned on, and a high potential is input to the point A. The combination of the two makes the potential of the point A low, T53 cannot be opened normally, so the point P(n) is at a low potential. That is, the inverter 10 always reverses potentials at the point Q(n) and the point P(n). However, due to a narrow bezel limit and a large load of 8K products, space for the GOA circuit is relatively tight. In current first pull-down maintenance module 106 and second pull-down maintenance module 107, each inverter needs 4 transistors to achieve that the potential of the point Q(n) and the potential of the point P(n) are opposite. This causes the GOA circuit to take up too much space and cannot meet needs of 8K products.

Therefore, the current GOA circuit has a technical problem of taking up too much space and needs to be improved.

### SUMMARY OF INVENTION

Embodiments of the present application provide a gate driver on array (GOA) circuit and a display panel to alleviate a technical problem that a current GOA circuit takes up too much space.

To solve the above issues, technical solutions provided by the present application are as follows:

An embodiment of the present application provides a gate driver on array (GOA) circuit comprising m cascaded GOA units. A nth-stage GOA unit comprises a pull-up control module connected to a first node and configured to pull up a potential of the first node according a previous-stage transmission signal, a pull-up module connected to the first node and configured to pull up a potential of a current-stage gate drive signal according to a current-stage clock signal, a signal downloading module connected to the first node and configured to control an output of a current-stage transmission signal according to the current-stage clock signal, a first pull-down module configured to pull down a potential of the current-stage gate drive signal according to a first post-stage gate drive signal, a second pull-down module connected to the first node and configured to pull down a potential of the first node according to a second post-stage gate drive signal, a first pull-down maintenance module connected to the first node and configured to maintain a low potential of the first node and a low potential of the current-stage gate drive signal according to a first low-frequency clock signal, and a second pull-down maintenance module connected to the first node and configured to maintain the low potential of the first node and the low potential of the current-stage gate drive signal according to a second low-frequency clock signal, the first low-frequency clock signal and the second low-frequency clock signal have opposite potentials at the same time. Both the first pull-down maintenance module and the second pull-down maintenance module comprise a reverse unit and a maintenance unit, an output terminal of the reverse unit is connected to an input terminal of the maintenance unit, and at least one reverse unit is a first reverse unit, the first reverse unit comprises a first reverse transistor, a second reverse transistor, and a third reverse transistor, a gate and a first electrode of the first reverse transistor is connected to an input terminal of a low-frequency clock signal, a second electrode of the first reverse transistor and a first electrode of the second reverse transistor are connected to a second node, a gate of the second reverse transistor is connected to the first node, a second electrode of the second reverse transistor is connected to a first low power supply potential signal, a gate and a first electrode of the third reverse transistor are connected to the second node, and a second electrode of the third reverse transistor is connected to the input terminal of the maintenance unit.

In an embodiment of the present application, reverse units of the first pull-down maintenance module and the second pull-down maintenance module are both first reverse units.

In an embodiment of the present application, one reverse unit of the first pull-down maintenance module and the second pull-down maintenance module is the first reverse unit and another reverse unit thereof is a second reverse unit, the second reverse unit comprises a fourth reverse transistor, a fifth reverse transistor, a sixth reverse transistor, and a seventh reverse transistor, a gate and a first electrode of the fourth reverse transistor are connected to the input terminal of the low-frequency clock signal, a second electrode of the fourth reverse transistor and a first electrode of the fifth reverse transistor are connected to a third node, a gate of the fifth reverse transistor is connected to the first node, a second electrode of the fifth reverse transistor is connected to the first low power supply potential signal, a gate of the sixth reverse transistor is connected to the third node, a first electrode of the sixth reverse transistor is connected to a first electrode of the fourth reverse transistor, a second electrode of the sixth reverse transistor and a first electrode of the seventh reverse transistor are connected to the input terminal of the maintenance unit, a gate of the seventh reverse transistor is connected to the first node, and a second electrode of the seventh reverse transistor is connected to the first low power supply potential signal.

In an embodiment of the present application, the maintenance unit comprises a first maintenance transistor and a second maintenance transistor, a gate of the first maintenance transistor and a gate of the second maintenance transistor are connected to the input terminal of the maintenance unit, a first electrode of the first maintenance transistor is connected to the first low power supply potential signal, a second electrode of the first maintenance transistor is connected to the first node, a first electrode of the second maintenance transistor is connected to a second low power supply potential signal, and a second electrode of the second maintenance transistor is connected to the current-stage gate drive signal.

In an embodiment of the present application, the pull-up control module comprises a first transistor, a gate and a first electrode of the first transistor are connected to the previous-stage transmission signal, and a second electrode thereof is connected to the first node.

In an embodiment of the present application, the pull-up module comprises a second transistor, a gate of the second transistor is connected to the first node, a first electrode thereof is connected to the current-stage clock signal, and a second electrode thereof is connected to the current-stage gate drive signal.

In an embodiment of the present application, the signal downloading module comprises a third transistor, a gate of the third transistor is connected to the first node, a first electrode thereof is connected to the current-stage clock signal, and the second electrode thereof is connected to the current-stage transmission signal.

In an embodiment of the present application, the first pull-down module comprises a fourth transistor, a gate of the fourth transistor is connected to the first post-stage gate drive signal, a first electrode thereof is connected to the second low power supply potential signal, and the second electrode thereof is connected to the current-stage gate drive signal.

In an embodiment of the present application, the second pull-down module comprises a fifth transistor, a gate of the fifth transistor is connected to the second post-stage gate drive signal, a first electrode thereof is connected to the first low power supply potential signal, and the second electrode thereof is connected to the first node.

In an embodiment of the present application, the first low-frequency clock signal, the second low-frequency clock signal, the first low power supply potential signal, and the second low power supply potential signal are all are provided by an external timing controller.

An embodiment of the present application further provides a display panel comprising a plurality of sub-pixels and a GOA circuit driving the sub-pixels. The GOA circuit comprises m cascaded GOA units. A nth-stage GOA unit comprises a pull-up control module connected to a first node and configured to pull up a potential of the first node according a previous-stage transmission signal, a pull-up module connected to the first node and configured to pull up a potential of a current-stage gate drive signal according to a current-stage clock signal, a signal downloading module connected to the first node and configured to control an output of a current-stage transmission signal according to the current-stage clock signal, a first pull-down module configured to pull down a potential of the current-stage gate drive signal according to a first post-stage gate drive signal, a second pull-down module connected to the first node and configured to pull down a potential of the first node according to a second post-stage gate drive signal, a first pull-down maintenance module connected to the first node and configured to maintain a low potential of the first node and a low potential of the current-stage gate drive signal according to a first low-frequency clock signal, and a second pull-down maintenance module connected to the first node and configured to maintain the low potential of the first node and the low potential of the current-stage gate drive signal according to a second low-frequency clock signal, the first low-frequency clock signal and the second low-frequency clock signal have opposite potentials at the same time. Both the first pull-down maintenance module and the second pull-down maintenance module comprise a reverse unit and a maintenance unit, an output terminal of the reverse unit is connected to an input terminal of the maintenance unit, and at least one reverse unit is a first reverse unit, the first reverse unit comprises a first reverse transistor, a second reverse transistor, and a third reverse transistor, a gate and a first electrode of the first reverse transistor is connected to an input terminal of a low-frequency clock signal, a second electrode of the first reverse transistor and a first electrode of the second reverse transistor are connected to a second node, a gate of the second reverse transistor is connected to the first node, a second electrode of the second reverse transistor is connected to a first low power supply potential signal, a gate and a first electrode of the third reverse transistor are connected to the second node, and a second electrode of the third reverse transistor is connected to the input terminal of the maintenance unit.

In an embodiment of the present application, reverse units of the first pull-down maintenance module and the second pull-down maintenance module are both first reverse units.

In an embodiment of the present application, one reverse unit of the first pull-down maintenance module and the second pull-down maintenance module is the first reverse unit and another reverse unit thereof is a second reverse unit, the second reverse unit comprises a fourth reverse transistor, a fifth reverse transistor, a sixth reverse transistor, and a seventh reverse transistor, a gate and a first electrode of the fourth reverse transistor are connected to the input terminal of the low-frequency clock signal, a second electrode of the fourth reverse transistor and a first electrode of the fifth reverse transistor are connected to a third node, a gate of the fifth reverse transistor is connected to the first node, a second electrode of the fifth reverse transistor is connected to the first low power supply potential signal, a gate of the sixth reverse transistor is connected to the third node, a first electrode of the sixth reverse transistor is connected to a first electrode of the fourth reverse transistor, a second electrode of the sixth reverse transistor and a first electrode of the seventh reverse transistor are connected to the input terminal of the maintenance unit, a gate of the seventh reverse transistor is connected to the first node, and a second electrode of the seventh reverse transistor is connected to the first low power supply potential signal.

In an embodiment of the present application, the maintenance unit comprises a first maintenance transistor and a second maintenance transistor, a gate of the first maintenance transistor and a gate of the second maintenance transistor are connected to the input terminal of the maintenance unit, a first electrode of the first maintenance transistor is connected to the first low power supply potential signal, a second electrode of the first maintenance transistor is connected to the first node, a first electrode of the second maintenance transistor is connected to a second low power supply potential signal, and a second electrode of the second maintenance transistor is connected to the current-stage gate drive signal.

In an embodiment of the present application, the pull-up control module comprises a first transistor, a gate and a first electrode of the first transistor are connected to the previous-stage transmission signal, and a second electrode thereof is connected to the first node.

In an embodiment of the present application, the pull-up module comprises a second transistor, a gate of the second transistor is connected to the first node, a first electrode thereof is connected to the current-stage clock signal, and a second electrode thereof is connected to the current-stage gate drive signal.

In an embodiment of the present application, the signal downloading module comprises a third transistor, a gate of the third transistor is connected to the first node, a first electrode thereof is connected to the current-stage clock signal, and the second electrode thereof is connected to the current-stage transmission signal.

In an embodiment of the present application, the first pull-down module comprises a fourth transistor, a gate of the fourth transistor is connected to the first post-stage gate drive signal, a first electrode thereof is connected to the second low power supply potential signal, and the second electrode thereof is connected to the current-stage gate drive signal.

In an embodiment of the present application, the second pull-down module comprises a fifth transistor, a gate of the fifth transistor is connected to the second post-stage gate drive signal, a first electrode thereof is connected to the first low power supply potential signal, and the second electrode thereof is connected to the first node.

In an embodiment of the present application, the first low-frequency clock signal, the second low-frequency clock signal, the first low power supply potential signal, and the second low power supply potential signal are all are provided by an external timing controller.

### Beneficial Effect

Beneficial effects of the present application: Embodiments of the present application provide a GOA circuit and display panel. The GOA circuit comprises m cascaded GOA units. A nth-stage GOA unit comprises a pull-up control module, a pull-up module a signal downloading module, a first pull-down module, a second pull-down module, a first pull-down maintenance module, and a second pull-down maintenance module. The pull-up control module is connected to a first node and is configured to pull up a potential of the first node according a previous-stage transmission signal. The pull-up module is connected to the first node and is configured to pull up a potential of a current-stage gate drive signal according to a current-stage clock signal. The signal downloading module is connected to the first node and is configured to control an output of a current-stage transmission signal according to the current-stage clock signal. The first pull-down module is configured to pull down a potential of the current-stage gate drive signal according to a first post-stage gate drive signal. The second pull-down module is connected to the first node and is configured to pull down a potential of the first node according to a second post-stage gate drive signal. The first pull-down maintenance module is connected to the first node and is configured to maintain a low potential of the first node and a low potential of the current-stage gate drive signal according to a first low-frequency clock signal. The second pull-down maintenance module is connected to the first node and is configured to maintain the low potential of the first node and the low potential of the current-stage gate drive signal according to a second low-frequency clock signal. The first low-frequency clock signal and the second low-frequency clock signal have opposite potentials at the same time. Both the first pull-down maintenance module and the second pull-down maintenance module comprise a reverse unit and a maintenance unit, an output terminal of the reverse unit is connected to an input terminal of the maintenance unit, and at least one reverse unit is a first reverse unit, the first reverse unit comprises a first reverse transistor, a second reverse transistor, and a third reverse transistor, a gate and a first electrode of the first reverse transistor is connected to an input terminal of a low-frequency clock signal, a second electrode of the first reverse transistor and a first electrode of the second reverse transistor are connected to a second node, a gate of the second reverse transistor is connected to the first node, a second electrode of the second reverse transistor is connected to a first low power supply potential signal, a gate and a first electrode of the third reverse transistor are connected to the second node, and a second electrode of the third reverse transistor is connected to the input terminal of the maintenance unit. In an embodiment of the present application, at least one reverse unit in the first pull-down maintenance module and the second pull-down maintenance module is set as the first reverse unit. In an operation phase of the first reverse unit, the input terminal of the low-frequency clock signal inputs a low-frequency clock signal having a high potential. When the potential of the first node is low, the second reverse transistor is turned off. The second node receives the high potential input by the first reverse transistor and turns on the third reverse transistor, so that the potential of the input terminal of the maintenance unit is high. When the first node is at a high potential, the second node simultaneously receives the high potential input by the first reverse transistor and the low potential input by the second reverse transistor. The potential of the second node is low, and the third reverse transistor cannot be turned on, so that the potential of the input terminal of the maintenance unit is low. In the first reverse unit, only three transistors can realize that the potential of the first node and the potential of the signal at the input terminal of the maintenance unit are opposite, thereby simplifying the GOA circuit structure and saving space.

### DESCRIPTION OF DRAWINGS

In order to more clearly explain the embodiments or the technical solutions in the prior art, the following will briefly introduce the drawings used in the description of the embodiments or the prior art. Obviously, the drawings in the following description are only disclosed For some embodiments, those of ordinary skill in the art can obtain other drawings based on these drawings without creative efforts.

FIG. 1 is a schematic structural diagram of a GOA circuit in the prior art.

FIG. 2 is a schematic structural diagram of a first pull-down maintenance module of a GOA circuit in the prior art.

FIG. 3 is a schematic diagram of a first structure of a GOA circuit according to an embodiment of the present application.

FIG. 4 is a schematic structural diagram of a first pull-down maintenance module of a GOA circuit according to an embodiment of the present application.

FIG. 5 is a schematic diagram of a film stacking structure of reverse units in a first pull-down maintenance module and a second pull-down maintenance module of the GOA circuit in the prior art.

FIG. 6 is a schematic diagram of a film stacking structure of a reverse unit in a first pull-down maintenance module and a second pull-down maintenance module of the GOA circuit according to an embodiment of the present application.

FIG. 7 is a schematic diagram of a second structure of a GOA circuit according to an embodiment of the present application.

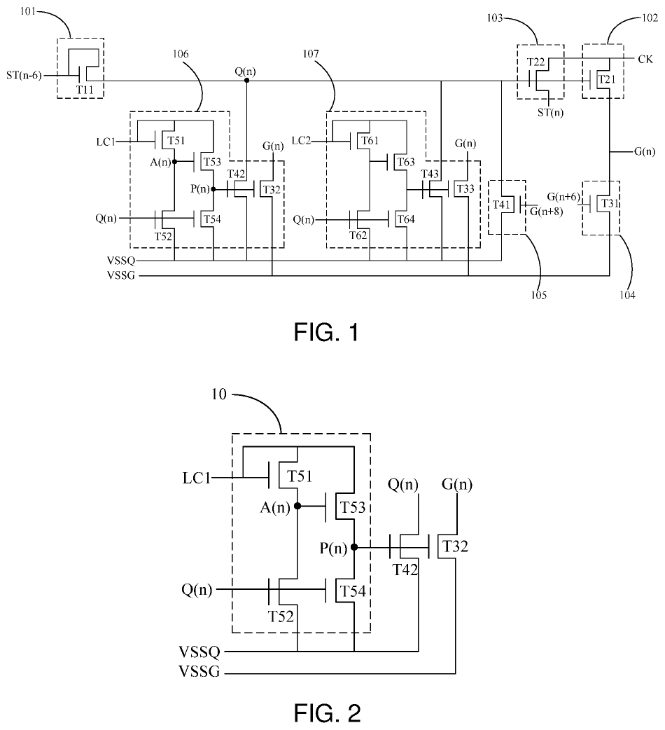

### DETAILED DESCRIPTION OF PREFERRED EMBODIMENTS

The following descriptions of the embodiments refer to the attached drawings to illustrate specific embodiments of the present invention that can be implemented. Directional terms mentioned in the present invention, such as “up”, “down”, “front”, “rear”, “left”, “right”, “inner”, “outer”, “side”, etc., just refer to the directions of the attached drawings. Therefore, the directional terminology is used to illustrate and understand the present invention, not to limit the present invention. In the figure, units with similar structures are indicated by the same reference numerals.

Embodiments of the present application provide a gate driver on array (GOA) circuit and a display panel to alleviate a technical problem that a current GOA circuit takes up too much space.

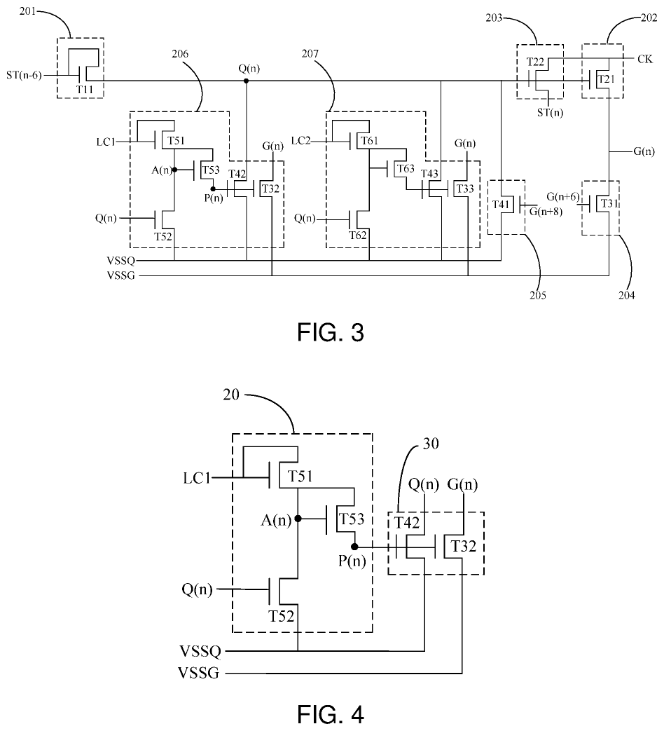

Referring to FIG. 3, which is a schematic diagram of a first structure of a GOA circuit according to an embodiment of the present application. The GOA circuit comprises m cascaded GOA units. A nth-stage GOA unit comprises a pull-up control module 201 connected to a first node Q(n) and configured to pull up a potential of the first node Q(n) according a previous-stage transmission signal, a pull-up module 202 connected to the first node Q(n) and configured to pull up a potential of a current-stage gate drive signal G(n) according to a current-stage clock signal CK, a signal downloading module 203 connected to the first node Q(n) and configured to control an output of a current-stage transmission signal ST(n) according to the current-stage clock signal CK, a first pull-down module 204 configured to pull down a potential of the current-stage gate drive signal G(n) according to a first post-stage gate drive signal, a second pull-down module 205 connected to the first node Q(n) and configured to pull down a potential of the first node Q(n) according to a second post-stage gate drive signal, a first pull-down maintenance module 206 connected to the first node Q(n) and configured to maintain a low potential of the first node Q(n) and a low potential of the current-stage gate drive signal G(n) according to a first low-frequency clock signal LC1, and a second pull-down maintenance module 207 connected to the first node Q(n) and configured to maintain the low potential of the first node Q(n) and the low potential of the current-stage gate drive signal G(n) according to a second low-frequency clock signal LC2, the first low-frequency clock signal LC1 and the second low-frequency clock signal LC2 have opposite potentials at the same time.

Both the first pull-down maintenance module 206 and the second pull-down maintenance module 207 comprise a reverse unit and a maintenance unit, an output terminal of the reverse unit is connected to an input terminal of the maintenance unit, and at least one reverse unit is a first reverse unit, the first reverse unit comprises a first reverse transistor, a second reverse transistor, and a third reverse transistor, a gate and a first electrode of the first reverse transistor is connected to an input terminal of a low-frequency clock signal, a second electrode of the first reverse transistor and a first electrode of the second reverse transistor are connected to a second node A(n), a gate of the second reverse transistor is connected to the first node Q(n), a second electrode of the second reverse transistor is connected to a first low power supply potential signal VSSQ, a gate and a first electrode of the third reverse transistor are connected to the second node A(n), and a second electrode of the third reverse transistor is connected to the input terminal of the maintenance unit.

The GOA circuit of an embodiment of the present application includes m cascaded GOA units. A transmission signal output by a nth-stage GOA unit is a nth-stage transmission signal ST(n), and an output gate drive signal thereof is a nth-stage gate drive signal G(n). 6≤n≤m, and n is an integer. A previous-stage transmission signal is a transmission signal of other GOA units before the nth stage GOA unit, and may be a previous first-stage, the previous second-stage, or the previous multiple-stage. A first post-stage gate drive signal and a second post-stage gate drive signal are gate drive signals of other GOA units after the nth stage GOA unit, and may be a post first-stage, a post second-stage, or a post multiple-stage. In an embodiment of the present application, a GOA circuit of a 8K product is used as an example, a previous-stage transmission signal is ST(n−6), a first post-stage gate drive signal is G(n+6), and a second post-stage gate drive signal is G(n+8). ST(n−6) is a transmission signal before the nth-stage gate drive signal G(n) and separated from it by six stages. The first post-stage gate drive signal G(n+6) is the gate drive signal after the nth stage gate drive signal G(n) and separated from it by six stages. The second post-stage gate drive signal G(n+8) is the gate drive signal after the nth stage gate drive signal G (n) and separated from it by eight stages.

In one embodiment, the pull-up control module 201 includes a first transistor T11, a gate and a first electrode of the first transistor T11 are connected to the previous-stage transmission signal ST(n−6), and a second electrode thereof is connected to the first node Q(n).

In one embodiment, the pull-up module 202 includes a second transistor T21, a gate of the second transistor T21 is connected to the first node Q(n), a first electrode thereof is connected to a current-stage clock signal CK, and a second electrode thereof is connected to a current-stage gate drive signal G(n).

In one embodiment, the signal downloading module 203 includes a third transistor T22, a gate of the third transistor T22 is connected to the first node Q(n), a first electrode thereof is connected to the-current stage clock signal CK, and a second electrode thereof is connected to the current-stage transmission signal ST(n).

In one embodiment, the first pull-down module 204 includes a fourth transistor T31, a gate of the fourth transistor T31 is connected to the first post-stage gate drive signal G(n+6), a first electrode thereof is connected to a second low power supply potential signal VSSG, and a second electrode thereof is connected to the current-stage gate drive signal G(n).

In one embodiment, the second pull-down module 205 includes a fifth transistor T41, a gate of the fifth transistor T41 is connected to the second post-stage gate drive signal G(n+8), a first electrode thereof is connected to the first low power supply potential signal VSSQ, and a second electrode thereof is connected to the first node Q(n).

In one embodiment, the first low-frequency clock signal LC1, the second low-frequency clock signal LC2, the first low power supply potential signal VSSQ, and the second low power supply potential signal VSSG are all provided by an external timing controller.

In an embodiment of the present application, both the first pull-down maintenance module 206 and the second pull-down maintenance module 207 are used to maintain a low potential of the first node Q(n) and a low potential of the current-stage gate drive signal G(n), therefore, the two have the same effect. When the GOA circuit is driven, an input terminal of a low-frequency clock signal of the first pull-down maintenance module 206 inputs the first low-frequency clock signal LC1, and an input terminal of a low-frequency clock signal of the second pull-down maintenance module 207 inputs the second low-frequency clock signal LC2. The first low-frequency clock signal LC1 and the second low-frequency clock signal LC2 are both 200 times the frame period and a low-frequency clock signal with a duty ratio of ½, and a phase difference between them is ½ period. At the same time, phases of the first low-frequency clock signal LC1 and the second low-frequency clock signal LC2 are opposite, so the first pull-down maintenance module 206 and the second pull-down maintenance module 207 can be driven to operate alternately. That is, the operation hours of the two are staggered, and only one pull-down maintenance module operates at the same time. Due to input characteristics of the first low-frequency clock signal LC1 and the second low-frequency clock signal LC2, for a pull-down maintenance module that operates at the time, its input terminal of the low-frequency clock signal is equivalent to receiving a DC signal. The DC signal is at a high potential and a value thereof is 28 V.

Both the first pull-down maintenance module 206 and the second pull-down maintenance module 207 include a reverse unit and a maintenance unit. An output terminal of the reverse unit is connected to an input terminal of the maintenance unit. At least one reverse unit is the first reverse unit. In this embodiment, the reverse units of the first pull-down maintenance module 206 and the second pull-down maintenance module 207 are both first reverse units. That is, structures of the first pull-down maintenance module 206 and the second pull-down maintenance module 207 are the same. Therefore, FIG. 4 takes the first pull-down maintenance module 206 as an example to describe structures of the first reverse unit and the maintenance unit, and the specific working principle is also applicable to the second pull-down maintenance module 207.

As illustrated in FIG. 3, the first pull-down maintenance module 206 includes a sixth transistor T51, a seventh transistor T52, an eighth transistor T53, a ninth transistor T42, and a tenth transistor T32. The second pull-down maintenance module 207 includes an eleventh transistor T61, a twelfth transistor T62, a thirteenth transistor T63, a fourteenth transistor T43, and a fifteenth transistor T33. As illustrated in FIG. 4, the first pull-down maintenance module 206 includes a first reverse unit 20 and a maintenance unit 30. In the first reverse unit 20, the sixth transistor T51 is a first reverse transistor, the seventh transistor T52 is a second reverse transistor, and the eighth transistor T53 is a third reverse transistor. In the maintenance unit 30, the ninth transistor T42 is a first maintenance transistor, and the tenth transistor T32 is a second maintenance transistor. Similarly, in the first reverse unit 20 of the second pull-down maintenance module 207, the eleventh transistor T61 is the first reverse transistor, the twelfth transistor T62 is the second reverse transistor, and the thirteenth transistor T63 is the third reverse transistor. In the maintenance unit 30 of the second pull-down maintenance module 207, the fourteenth transistor T43 is a first maintenance transistor, and the fifteenth transistor T33 is a second maintenance transistor.

In an embodiment of the present application, one of the first electrode and the second electrode of each transistor is a source, and the other is drain. The first reverse transistor, the second reverse transistor, the third reverse transistor, the first maintenance transistor, the second maintenance transistor, and other transistors are all N-type or P-type transistors.

In FIG. 4, a gate and a first electrode of the sixth transistor T51 are connected to an input terminal of a low-frequency clock signal, and a second electrode of the sixth transistor T51 and a first electrode of the seventh transistor T52 are connected to the second node A(n). A gate of the seventh transistor T52 is connected to the first node Q(n), and a second electrode of the seventh transistor T52 is connected to the first low power supply potential signal VSSQ. A gate and a first electrode of the eighth transistor T53 are connected to the second node A(n), and a second electrode of the eighth transistor T53 is connected to an input terminal of the maintenance unit 30. A gate of the ninth transistor T42 and a gate of the tenth transistor T32 are connected to the input terminal of the maintenance unit 30. A first electrode of the ninth transistor T42 is connected to the first low power supply potential signal VSSQ, and a second electrode of the ninth transistor T42 is connected to the first node Q(n). A first electrode of the tenth transistor T32 is connected to the second low power supply potential signal VSSG, and a second electrode of the tenth transistor T32 is connected to the current-stage gate drive signal G(n). The first low-frequency clock signal LC1 is input to the input terminal of the low-frequency clock signal, and the input terminal of the maintenance unit 30 is connected to a fourth node P(n).

When the first pull-down maintenance module 206 operates, the signal input to the input terminal of the low-frequency clock signal of the first reverse unit 20 is equivalent to a DC signal, and a value thereof is 28 V. That is, during operation, the first low-frequency clock signal LC1 is always at a high potential, so the sixth transistor T51 is always on, pulling a potential of the second node A(n) high. When the first node Q(n) is at a high potential, the seventh transistor T52 is turned on, and the first low power supply potential signal VSSQ pulls the potential of the second node A(n) low. Therefore, the second node A(n) simultaneously receives a high potential input from the sixth transistor T51 and a low potential input from the seventh transistor T52, so that the potential of the second node A(n) is low, which is not enough to turn on the eighth transistor T53. Therefore, a potential of the fourth node P(n) is low, that is, the potential of the input terminal of the sustain unit is low, and the ninth transistor T42 and the tenth transistor T32 are turned off. When the first node Q (n) is at a low potential, the seventh transistor T52 is turned off, and the second node A (n) only receives the high potential input by the sixth transistor T51. Therefore, the potential of the second node A (n) is high, so that the eighth transistor T53 is turned on, and the potential of the fourth node P (n) is high, that is, the input terminal potential of the maintenance unit 30 is high. The ninth transistor T42 and the tenth transistor T32 are turned on, and input the first low power supply potential signal VSSQ and the second low power supply potential signal VSSG to the first node Q(n) and the current-stage gate drive signal G(n), the potentials of both are maintained at a low potential.

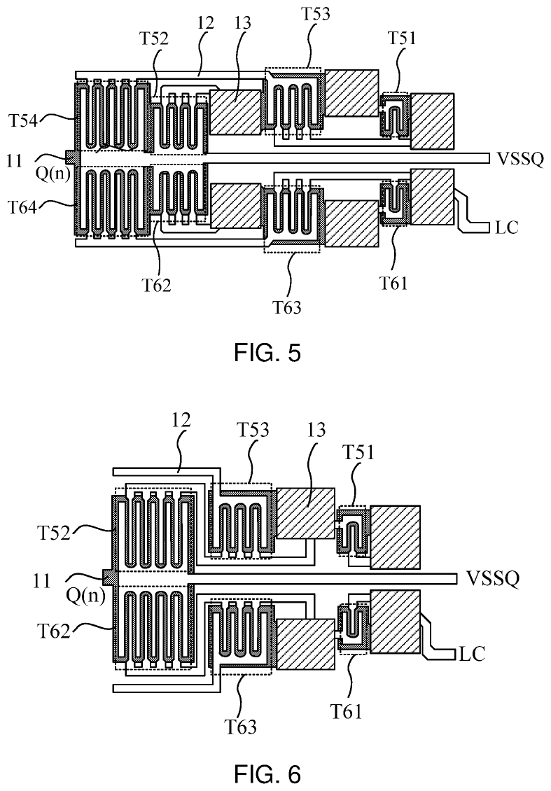

FIG. 5 and FIG. 6 respectively illustrate a film stacking structure of reverse units in a first pull-down maintenance module and a second pull-down maintenance module in a GOA circuit in the prior art and an embodiment of the present application. Each film layer includes a first metal layer 11, a source-drain layer 12, and a connection member 13. A portion where the first metal layer 11 overlaps an active layer (not shown) forms a gate of each transistor. In addition, a first node Q(n) is formed. The source-drain layer 12 forms a source and a drain of each transistor, a first low power supply potential signal line VSSQ, and a low-frequency clock signal line LC. One end of the connection member 13 covers the source-drain layer 12, and another end thereof is connected to a via hole in the first metal layer 11 to realize connection between a gate of one transistor and a source or a drain of another transistor. Material of the connection member 13 includes indium tin oxide.

It can be seen from comparison between FIG. 5 and FIG. 6 that in the prior art, each reverse unit needs to be provided with four transistors, and three connection members are required for connection. The structure is more complicated and takes up more space. In an embodiment of the present application, each reverse unit only needs to be provided with three transistors, and only two connection members are needed for connection. The structure is relatively simple, takes up less space, and simplifies a manufacturing process and saves costs.

In the first pull-down maintenance module 206 and the second pull-down maintenance module 207 of this embodiment, the reverse units are both the first reverse units 20. Each first reverse unit 20 only needs to use three transistors to realize that signals of potentials at the input terminal of the first node and the maintenance unit are opposite. Therefore, the nth-stage GOA unit in the GOA circuit only needs 16 transistors. Compared with the prior art, two transistors are reduced, so that the structure of the GOA circuit is simplified, and occupied space of the GOA circuit is saved. For each GOA unit in the GOA circuit, same settings as the nth-stage GOA unit can be used.

In the above embodiments, the reverse units of the first pull-down maintenance module 206 and the second pull-down maintenance module 207 are both the first reverse units 20, but the present application is not limited thereto. In one embodiment, one of the reverse units of the first pull-down maintenance module 206 and the second pull-down maintenance module 207 is the first reverse unit, and another reverse unit thereof is the second reverse unit. The second reverse unit includes a fourth reverse transistor, a fifth reverse transistor, a sixth reverse transistor, and a seventh reverse transistor. A gate and a first electrode of the fourth reverse transistor are connected to an input terminal of a low-frequency clock signal, and a second electrode of the fourth reverse transistor and a first electrode of the fifth reverse transistor are connected to a third node. A gate of the fifth reverse transistor is connected to the first node, and a second electrode of the fifth reverse transistor is connected to the first low power supply potential signal. A gate of the sixth reverse transistor is connected to the third node, and a first electrode of the sixth reverse transistor is connected to the first electrode of the fourth reverse transistor. A second electrode of the sixth reverse transistor and a first electrode of the seventh reverse transistor are connected to the input terminal of the maintenance unit. A gate of the seventh reverse transistor is connected to the first node, and a second electrode of the seventh reverse transistor is connected to the first low power supply potential signal.

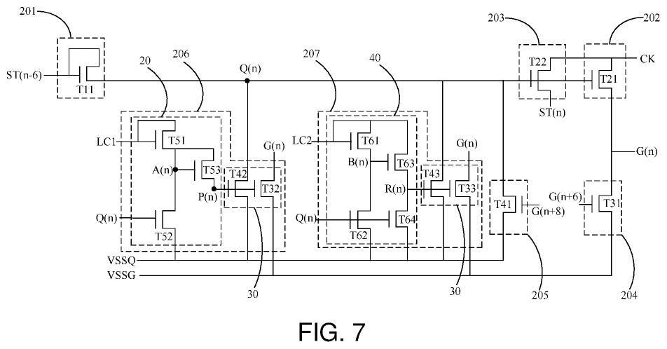

As illustrated in FIG. 7, which is a schematic diagram of a second structure of a GOA circuit according to an embodiment of the present application. In this embodiment, the reverse unit of the first pull-down maintenance module 206 is the first reverse unit 20, and the structure is the same as that in FIG. 4. The reverse unit of the second pull-down maintenance module 207 is the second reverse unit 40. The second reverse unit 40 includes an eleventh transistor T61, a twelfth transistor T62, a thirteenth transistor T63, and a sixteenth transistor T64. The eleventh transistor T61 is a fourth reverse transistor, the twelfth transistor T62 is a fifth reverse transistor, the thirteenth transistor T63 is a sixth reverse transistor, and the sixteenth transistor T64 is a seventh reverse transistor.

A gate and a first electrode of the eleventh transistor T61 are connected to the input terminal of the low-frequency clock signal, and a second electrode of the eleventh transistor T61 and a first electrode of the twelfth transistor T62 are connected to a third node B(n). A gate of the twelfth transistor T62 is connected to the first node Q(n), and a second electrode of the twelfth transistor T62 is connected to the first low power supply potential signal VSSQ. A gate of the thirteenth transistor T63 is connected to the third node B(n), and a first electrode of the thirteenth transistor T63 is connected to the first electrode of the eleventh transistor T61. A second electrode of the thirteenth transistor T63 and a first electrode of the sixteenth transistor T64 are connected to the input terminal of the maintenance unit 30. A gate of the sixteenth transistor T64 is connected to the first node Q(n), and a second electrode of the sixteenth transistor T64 is connected to the first low power supply potential signal VSSQ. The input terminal of the low-frequency clock signal inputs the second low-frequency clock signal LC2, and the input terminal of the maintenance unit 30 is connected to a fifth node R(n).

The structure in the second reverse unit 40 is the same as that in the prior art, so it can also play the role that the potential of the first node Q(n) is opposite to the potential of the input terminal of the maintenance unit 30. In this embodiment, the reverse unit of the first pull-down maintenance module 206 is designed as the first reverse unit 20, and the reverse unit of the second pull-down maintenance module 207 is designed as the second reverse unit 40, or the reverse unit of the first pull-down maintenance module 206 is designed as the second reverse unit 40, and the reverse unit of the second pull-down maintenance module 207 is designed as the first reverse unit 20. All of these can make the total number of transistors in the nth-stage GOA unit be 16, which is reduced by one transistor compared with the prior art, thus simplifying the GOA circuit structure, and saving occupied space.

An embodiment of the present application further provides a display panel, which may be a liquid crystal display panel or an organic light emitting diode (OLED) display panel. The display panel includes multiple sub-pixels and a GOA circuit that drives the sub-pixels. The GOA circuit is the GOA circuit described in any of the above embodiments, and can be applied to 8K products with a display panel resolution of 7680*4320. Compared with the prior art, the GOA circuit in the display panel according to an embodiment of the present application reduces the number of transistors without affecting current functions, so that occupied space of the GOA circuit is reduced, which is more conducive to achieving a narrow bezel design.

According to the above embodiments:

Embodiments of the present application provide a GOA circuit and display panel. The GOA circuit comprises m cascaded GOA units. A nth-stage GOA unit comprises a pull-up control module, a pull-up module a signal downloading module, a first pull-down module, a second pull-down module, a first pull-down maintenance module, and a second pull-down maintenance module. The pull-up control module is connected to a first node and is configured to pull up a potential of the first node according a previous-stage transmission signal. The pull-up module is connected to the first node and is configured to pull up a potential of a current-stage gate drive signal according to a current-stage clock signal. The signal downloading module is connected to the first node and is configured to control an output of a current-stage transmission signal according to the current-stage clock signal. The first pull-down module is configured to pull down a potential of the current-stage gate drive signal according to a first post-stage gate drive signal. The second pull-down module is connected to the first node and is configured to pull down a potential of the first node according to a second post-stage gate drive signal. The first pull-down maintenance module is connected to the first node and is configured to maintain a low potential of the first node and a low potential of the current-stage gate drive signal according to a first low-frequency clock signal. The second pull-down maintenance module is connected to the first node and is configured to maintain the low potential of the first node and the low potential of the current-stage gate drive signal according to a second low-frequency clock signal. The first low-frequency clock signal and the second low-frequency clock signal have opposite potentials at the same time. Both the first pull-down maintenance module and the second pull-down maintenance module comprise a reverse unit and a maintenance unit, an output terminal of the reverse unit is connected to an input terminal of the maintenance unit, and at least one reverse unit is a first reverse unit, the first reverse unit comprises a first reverse transistor, a second reverse transistor, and a third reverse transistor, a gate and a first electrode of the first reverse transistor is connected to an input terminal of a low-frequency clock signal, a second electrode of the first reverse transistor and a first electrode of the second reverse transistor are connected to a second node, a gate of the second reverse transistor is connected to the first node, a second electrode of the second reverse transistor is connected to a first low power supply potential signal, a gate and a first electrode of the third reverse transistor are connected to the second node, and a second electrode of the third reverse transistor is connected to the input terminal of the maintenance unit. In an embodiment of the present application, at least one reverse unit in the first pull-down maintenance module and the second pull-down maintenance module is set as the first reverse unit. In an operation phase of the first reverse unit, the input terminal of the low-frequency clock signal inputs a low-frequency clock signal having a high potential. When the potential of the first node is low, the second reverse transistor is turned off. The second node receives the high potential input by the first reverse transistor and turns on the third reverse transistor, so that the potential of the input terminal of the maintenance unit is high. When the first node is at a high potential, the second node simultaneously receives the high potential input by the first reverse transistor and the low potential input by the second reverse transistor. The potential of the second node is low, and the third reverse transistor cannot be turned on, so that the potential of the input terminal of the maintenance unit is low. In the first reverse unit, only three transistors can realize that the potential of the first node and the potential of the signal at the input terminal of the maintenance unit are opposite, thereby simplifying the GOA circuit structure and saving space.

In the above embodiments, the description of each embodiment has its own emphasis. For a part that is not detailed in an embodiment, refer to related descriptions in other embodiments.

The GOA circuit and the display panel provided by the embodiments of the present application have been described in detail above. This article uses specific examples to explain the principles and implementation of the present application. The descriptions of the above embodiments are only used to help understand the technical solutions and core ideas of the present application. Persons of ordinary skill in the art should understand that they can still modify the technical solutions described in the foregoing embodiments, or equivalently replace some of the technical features. However, these modifications or substitutions do not deviate the essence of the corresponding technical solutions from the scope of the technical solutions of the embodiments of the present application.

In summary, although the present disclosure is disclosed as above with preferred embodiments, the above preferred embodiments are not intended to limit the present disclosure. Those of ordinary skill in the art can make various changes and modifications without departing from the spirit and scope of the present disclosure, so the protection scope of the present disclosure is based on the scope defined by the claims.

What is claimed is:

1. A gate driver on array (GOA) circuit, comprising:
m cascaded GOA units, wherein a nth-stage GOA unit comprises:
a pull-up control module connected to a first node and configured to pull up a potential of the first node according a previous-stage transmission signal;
a pull-up module connected to the first node and configured to pull up a potential of a current-stage gate drive signal according to a current-stage clock signal;
a signal downloading module connected to the first node and configured to control an output of a current-stage transmission signal according to the current-stage clock signal;
a first pull-down module configured to pull down a potential of the current-stage gate drive signal according to a first post-stage gate drive signal;
a second pull-down module connected to the first node and configured to pull down a potential of the first node according to a second post-stage gate drive signal;
a first pull-down maintenance module connected to the first node and configured to maintain a low potential of the first node and a low potential of the current-stage gate drive signal according to a first low-frequency clock signal; and
a second pull-down maintenance module connected to the first node and configured to maintain the low potential of the first node and the low potential of the current-stage gate drive signal according to a second low-frequency clock signal, the first low-frequency clock signal and the second low-frequency clock signal have opposite potentials at the same time;
wherein both the first pull-down maintenance module and the second pull-down maintenance module comprise a reverse unit and a maintenance unit, an output terminal of the reverse unit is connected to an input terminal of the maintenance unit, and at least one reverse unit is a first reverse unit; the first reverse unit comprises a first reverse transistor, a second reverse transistor, and a third reverse transistor, a gate and a first electrode of the first reverse transistor is connected to an input terminal of a low-frequency clock signal, a second electrode of the first reverse transistor and a first electrode of the second reverse transistor are connected to a second node, a gate of the second reverse transistor is connected to the first node, a second electrode of the second reverse transistor is connected to a first low power supply potential signal, a gate and a first electrode of the third reverse transistor are connected to the second node, and a second electrode of the third reverse transistor is connected to the input terminal of the maintenance unit.

2. The GOA circuit according to claim 1, wherein reverse units of the first pull-down maintenance module and the second pull-down maintenance module are both first reverse units.

3. The GOA circuit according to claim 1, wherein one reverse unit of the first pull-down maintenance module and the second pull-down maintenance module is the first reverse unit and another reverse unit thereof is a second reverse unit, the second reverse unit comprises a fourth reverse transistor, a fifth reverse transistor, a sixth reverse transistor, and a seventh reverse transistor, a gate and a first electrode of the fourth reverse transistor are connected to the input terminal of the low-frequency clock signal, a second electrode of the fourth reverse transistor and a first electrode of the fifth reverse transistor are connected to a third node, a gate of the fifth reverse transistor is connected to the first node, a second electrode of the fifth reverse transistor is connected to the first low power supply potential signal, a gate of the sixth reverse transistor is connected to the third node, a first electrode of the sixth reverse transistor is connected to a first electrode of the fourth reverse transistor, a second electrode of the sixth reverse transistor and a first electrode of the seventh reverse transistor are connected to the input terminal of the maintenance unit, a gate of the seventh reverse transistor is connected to the first node, and a second electrode of the seventh reverse transistor is connected to the first low power supply potential signal.

4. The GOA circuit according to claim 1, wherein the maintenance unit comprises a first maintenance transistor and a second maintenance transistor, a gate of the first maintenance transistor and a gate of the second maintenance transistor are connected to the input terminal of the maintenance unit, a first electrode of the first maintenance transistor is connected to the first low power supply potential signal, a second electrode of the first maintenance transistor is connected to the first node, a first electrode of the second maintenance transistor is connected to a second low power supply potential signal, and a second electrode of the second maintenance transistor is connected to the current-stage gate drive signal.

5. The GOA circuit according to claim 4, wherein the pull-up control module comprises a first transistor, a gate and a first electrode of the first transistor are connected to the previous-stage transmission signal, and a second electrode thereof is connected to the first node.

6. The GOA circuit according to claim 5, wherein the pull-up module comprises a second transistor, a gate of the second transistor is connected to the first node, a first electrode thereof is connected to the current-stage clock signal, and a second electrode thereof is connected to the current-stage gate drive signal.

7. The GOA circuit according to claim 6, wherein the signal downloading module comprises a third transistor, a gate of the third transistor is connected to the first node, a first electrode thereof is connected to the current-stage clock signal, and the second electrode thereof is connected to the current-stage transmission signal.

8. The GOA circuit according to claim 7, wherein the first pull-down module comprises a fourth transistor, a gate of the fourth transistor is connected to the first post-stage gate drive signal, a first electrode thereof is connected to the second low power supply potential signal, and the second electrode thereof is connected to the current-stage gate drive signal.

9. The GOA circuit according to claim 8, wherein the second pull-down module comprises a fifth transistor, a gate of the fifth transistor is connected to the second post-stage gate drive signal, a first electrode thereof is connected to the first low power supply potential signal, and the second electrode thereof is connected to the first node.

10. The GOA circuit according to claim 9, wherein the first low-frequency clock signal, the second low-frequency clock signal, the first low power supply potential signal, and the second low power supply potential signal are all are provided by an external timing controller.

11. A display panel, comprising:
a plurality of sub-pixels and a GOA circuit driving the sub-pixels, wherein the GOA circuit comprises m cascaded GOA units, and a nth-stage GOA unit comprises:
a pull-up control module connected to a first node and configured to pull up a potential of the first node according a previous-stage transmission signal;
a pull-up module connected to the first node and configured to pull up a potential of a current-stage gate drive signal according to a current-stage clock signal;
a signal downloading module connected to the first node and configured to control an output of a current-stage transmission signal according to the current-stage clock signal;
a first pull-down module configured to pull down a potential of the current-stage gate drive signal according to a first post-stage gate drive signal;
a second pull-down module connected to the first node and configured to pull down a potential of the first node according to a second post-stage gate drive signal;
a first pull-down maintenance module connected to the first node and configured to maintain a low potential of the first node and a low potential of the current-stage gate drive signal according to a first low-frequency clock signal; and
a second pull-down maintenance module connected to the first node and configured to maintain the low potential of the first node and the low potential of the current-stage gate drive signal according to a second low-frequency clock signal, the first low-frequency clock signal and the second low-frequency clock signal have opposite potentials at the same time;
wherein both the first pull-down maintenance module and the second pull-down maintenance module comprise a reverse unit and a maintenance unit, an output terminal of the reverse unit is connected to an input terminal of the maintenance unit, and at least one reverse unit is a first reverse unit; the first reverse unit comprises a first reverse transistor, a second reverse transistor, and a third reverse transistor, a gate and a first electrode of the first reverse transistor is connected to an input terminal of a low-frequency clock signal, a second electrode of the first reverse transistor and a first electrode of the second reverse transistor are connected to a second node, a gate of the second reverse transistor is connected to the first node, a second electrode of the second reverse transistor is connected to a first low power supply potential signal, a gate and a first electrode of the third reverse transistor are connected to the second node, and a second electrode of the third reverse transistor is connected to the input terminal of the maintenance unit.

12. The display panel according to claim 11, wherein reverse units of the first pull-down maintenance module and the second pull-down maintenance module are both first reverse units.

13. The display panel according to claim 11, wherein one reverse unit of the first pull-down maintenance module and the second pull-down maintenance module is the first reverse unit and another reverse unit thereof is a second reverse unit, the second reverse unit comprises a fourth reverse transistor, a fifth reverse transistor, a sixth reverse transistor, and a seventh reverse transistor, a gate and a first electrode of the fourth reverse transistor are connected to the input terminal of the low-frequency clock signal, a second electrode of the fourth reverse transistor and a first electrode of the fifth reverse transistor are connected to a third node, a gate of the fifth reverse transistor is connected to the first node, a second electrode of the fifth reverse transistor is connected to the first low power supply potential signal, a gate of the sixth reverse transistor is connected to the third node, a first electrode of the sixth reverse transistor is connected to a first electrode of the fourth reverse transistor, a second electrode of the sixth reverse transistor and a first electrode of the seventh reverse transistor are connected to the input terminal of the maintenance unit, a gate of the seventh reverse transistor is connected to the first node, and a second electrode of the seventh reverse transistor is connected to the first low power supply potential signal.

14. The display panel according to claim 11, wherein the maintenance unit comprises a first maintenance transistor and a second maintenance transistor, a gate of the first maintenance transistor and a gate of the second maintenance transistor are connected to the input terminal of the maintenance unit, a first electrode of the first maintenance transistor is connected to the first low power supply potential signal, a second electrode of the first maintenance transistor is connected to the first node, a first electrode of the second maintenance transistor is connected to a second low power supply potential signal, and a second electrode of the second maintenance transistor is connected to the current-stage gate drive signal.

15. The display panel according to claim 14, wherein the pull-up control module comprises a first transistor, a gate and a first electrode of the first transistor are connected to the previous-stage transmission signal, and a second electrode thereof is connected to the first node.

16. The display panel according to claim 15, wherein the pull-up module comprises a second transistor, a gate of the second transistor is connected to the first node, a first electrode thereof is connected to the current-stage clock signal, and a second electrode thereof is connected to the current-stage gate drive signal.

17. The display panel according to claim 16, wherein the signal downloading module comprises a third transistor, a gate of the third transistor is connected to the first node, a first electrode thereof is connected to the current-stage clock signal, and the second electrode thereof is connected to the current-stage transmission signal.

18. The display panel according to claim 17, wherein the first pull-down module comprises a fourth transistor, a gate of the fourth transistor is connected to the first post-stage gate drive signal, a first electrode thereof is connected to the second low power supply potential signal, and the second electrode thereof is connected to the current-stage gate drive signal.

19. The display panel according to claim 18, wherein the second pull-down module comprises a fifth transistor, a gate of the fifth transistor is connected to the second post-stage gate drive signal, a first electrode thereof is connected to the first low power supply potential signal, and the second electrode thereof is connected to the first node.

20. The display panel according to claim 19, wherein the first low-frequency clock signal, the second low-frequency clock signal, the first low power supply potential signal, and the second low power supply potential signal are all are provided by an external timing controller.
